(19) United States
(12) Patent Application Publication
(10) Pub. No.: US 2023/0254638 A1
(43) Pub. Date: Aug. 10, 2023

(54) PERIPHERAL MICROPHONES

(71) Applicant: Hewlett-Packard Development Company, L.P., Spring, TX (US)

(72) Inventors: WEI HUNG LIN, TAIPEI CITY (TW); SHIH HUNG CHANG, TAIPEI CITY (TW); KAI CHIH YANG, TAIPEI CITY (TW)

(73) Assignee: Hewlett-Packard Development Company, L.P., Spring, TX (US)

(21) Appl. No.: 18/006,711

(22) PCT Filed: Aug. 5, 2020
(86) PCT No.: PCT/US2020/044963

§ 371 Date: Jan. 24, 2023

(51) Int. Cl. H04R 3/00; H04R 29/00; H04R 1/40

(52) U.S. Cl. CPC H04R 3/005; H04R 1/406; H04R 29/005; H04R 2201/401; H04R 2410/01

(57) ABSTRACT

In some examples of the present disclosure, a non-transitory memory resource storing machine-readable instructions can cause a processing resource of a computing device to: instruct a first microphone of the computing device and a second microphone of a peripheral device to capture an audio signal generated by an audio source, determine a location of the second microphone based on a proximity of the peripheral device to the audio source, and alter a sound property of the audio signal based on a location of the first microphone and the location of the second microphone.

### BACKGROUND

A computing device can allow a user to utilize computing device operations for work, education, gaming, multimedia, and/or other uses. Computing devices can be utilized in a non-portable setting, such as at a desktop, and/or be portable to allow a user to carry of otherwise bring with the computing device with while in a mobile setting. These computing devices can be utilized to receive audio signals that can be utilized for a variety of purposes.

### BRIEF DESCRIPTION OF THE DRAWINGS

FIG. 1 illustrates an example of a memory resource storing instructions for utilizing peripheral microphones.

FIG. 2 illustrates an example of a computing device for utilizing peripheral microphones.

FIG. 3 illustrates an example of a device for utilizing peripheral microphones.

FIG. 4 illustrates an example of a system for utilizing peripheral microphones.

### DETAILED DESCRIPTION

A user may utilize a computing device for various purposes, such as for business and/or recreational use. As used herein, the term “computing device” refers to an electronic system having a processing resource and a memory resource. Examples of computing devices can include, for instance, a laptop computer, a notebook computer, a desktop computer, networking device (e.g., router, switch, etc.), and/or a mobile device (e.g., a smart phone, tablet, personal digital assistant, smart glasses, a wrist-worn device, etc.), among other types of computing devices. As used herein, a mobile device refers to devices that are (or can be) carried and/or worn by a user. For example, a mobile device can be a phone (e.g., a smart phone), a tablet, a personal digital assistant (PDA), smart glasses, and/or a wrist-worn device (e.g., a smart watch), among other types of mobile devices.

In some examples, computing devices can be utilized to capture sound utilizing microphones or similar devices. In some examples, the computing devices can capture the sound and generate audio data (e.g., audio files, digital audio data, analog audio data, etc.) that can be stored, altered, and/or transmitted to other devices. For example, the computing device can be utilized as a platform for a teleconference or telecommunication session. In this example, the computing device can receive audio signals from a user in the form of a conversation, enhance or alter audio data generated in response to receiving the audio signals, and transmit the audio data to a different device. In some examples, the audio data can be altered to increase an audio quality of the audio data. As used herein, an audio quality can correspond to a particular signal to noise ratio of the audio data. In some examples, an audio quality can be deemed to have relatively high quality when the signal to noise ratio is relatively high and deemed to relatively low quality when the signal to noise ratio is relatively low. In this way, properties of the audio data can be altered to increase the signal to noise ratio and thus increase the audio quality of the audio data.

The present disclosure relates to utilizing peripheral microphones to increase an audio quality of audio data. In some examples, the computing device can include instructions that when executed by a processing resource can cause the processing resource to capture audio signals from a microphone of a peripheral device. In these examples, the computing device can determine a location of the peripheral device and utilize the location to identify a proximity between the peripheral device and a source of the audio signal. In this way, the received audio signal can be utilized to alter properties of audio data associated with the audio signal based on the proximity between the peripheral device and the source of the audio signal. For example, when the peripheral device is relatively closer to the source of the audio signal, the signal or intended sound can be utilized to increase a signal to noise ratio of the audio data. In another example, when the peripheral device is relatively further away from the source of the audio signal, the noise or unintended sound can be utilized to remove noise from the audio data.

In addition, the location of the peripheral device relative to the source of the audio signal can be utilized to generate alerts to move the peripheral device to a different location to increase the signal to noise ratio of the captured audio data from the microphone of the peripheral device. In this way, the present disclosure can utilize audio data captured by peripheral devices to increase an audio quality of audio data captured by other microphones associated with the computing device.

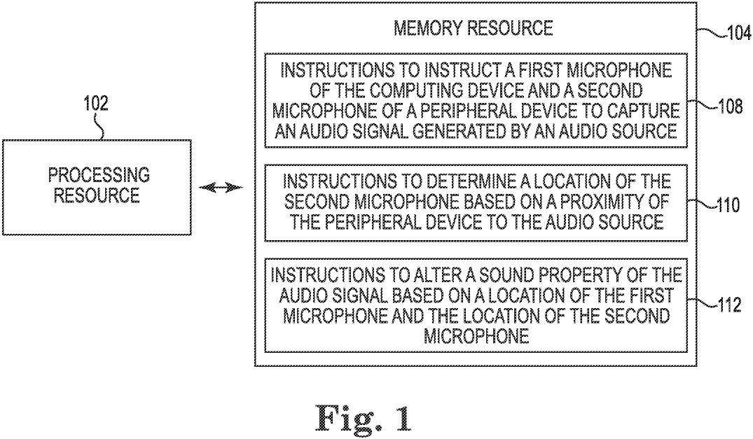

FIG. 1 illustrates an example of a memory resource 104 storing instructions 108, 110, 112 for utilizing peripheral microphones. In some examples, the memory resource 104 can be a part of a computing device or controller that can be communicatively coupled to a computing system that includes an enclosure, microphones, and/or peripheral devices. In some examples, the memory resource 104 can be communicatively coupled to a processing resource 102 that can execute instructions 108, 110, 112 stored on the memory resource 104. For example, the memory resource 104 can be communicatively coupled to the processing resource 102 through a communication path 106. In some examples, a communication path 106 can include a wired or wireless connection that can allow communication between devices.

The processing resource 102 can be a component of a computing device such as a processor, an application specific integrated circuit (ASIC), a field programmable gate array (FPGA), a metal-programmable cell array (MPCA), or other combination of circuitry and/or logic to orchestrate execution of instructions 108, 110, 112. In a specific example, the memory resource 104 is a non-transitory computer-readable medium storing instructions 108, 110, 112 that, when executed, cause the processing resource 102 to perform corresponding functions.

The memory resource 104 may be electronic, magnetic, optical, or other physical storage device that stores executable instructions. Thus, non-transitory machine readable medium (e.g., a memory resource 104) may be, for example, a non-transitory MRM comprising Random-Access Memory (RAM), an Electrically-Erasable Programmable ROM (EEPROM), a storage drive, an optical disc, and the like. The non-transitory machine readable medium (e.g., a memory resource 104) may be disposed within a controller and/or computing device. In this example, the executable instructions 108, 110, 112 can be “installed” on the device. Additionally, and/or alternatively, the non-transitory machine readable medium (e.g., a memory resource) can be a portable, external or remote storage medium, for example, that allows a computing system to download the instructions 108, 110, 112 from the portable/external/remote storage medium. In this situation, the executable instructions may be part of an “installation package”. As described herein, the non-transitory machine readable medium (e.g., a memory resource 104) can be encoded with executable instructions for utilizing peripheral device microphones.

The instructions 108, when executed by a processing resource such as the processing resource 102, can include instructions to instruct a first microphone of the computing device and a second microphone of a peripheral device to capture an audio signal generated by an audio source. As used herein, a microphone can include a device that is capable of converting sound waves into electrical energy variations which may then be amplified, transmitted, or recorded. In some examples, the first microphone of the computing device can be a microphone that is permanently or semi-permanently attached to a computing device. For example, the computing device can include an enclosure and the microphone can be disposed within the enclosure when the computing device is manufactured.

In some examples, the second microphone of the peripheral device can be a microphone that is permanently or semi-permanently attached to a particular peripheral device. As used herein, a peripheral device can include a device that is ancillary or separate from the computing device. For example, a peripheral device can include an enclosure that is separate and/or distinct from an enclosure of the computing device. Examples of peripheral devices can include, but are not limited to: a computing mouse, a stylus, a video camera, a remote control, a computing hub, among other devices that can be physically separate from the computing device while being able to communicate with the computing device. In this way, the second microphone of the peripheral device can be moved to a plurality of different locations even when the location of the computing device remains the same or similar. For example, the computing device can be a laptop that is positioned on a work surface. In this example, the peripheral device can be a stylus that includes the second microphone and the stylus can be moved by a user or device to a plurality of locations around the laptop without moving the laptop from the work surface.

In some examples, the first microphone and the second microphone can be utilized to capture an audio signal generated by an audio source. As used herein, an audio source can be a user or device that is generating sound waves to be captured as the audio signal by microphones. As used herein, the audio signal can include sound waves generated by the audio source and captured by the microphone. In some examples, the audio signal can be converted to an electrical signal or audio data. As used herein, audio data can include converted audio signals that can be utilized by a computing device. For example, the audio data can be stored on a memory resource, transmitted to different devices, and/or played through a speaker device.

The instructions 110, when executed by a processing resource such as the processing resource 102, can include instructions to determine a location of the second microphone based on a proximity of the peripheral device to the audio source. As described herein, the peripheral device can be moved to a plurality of locations without having to physically move the computing device. In this way, a current location of the peripheral device can be determined based on a proximity of the peripheral device to the audio source. For example, the peripheral device can utilize particular coupling locations to the computing device enclosure. In this example, the coupling locations can be utilized to store the peripheral device. In these examples, the computing device can determine the coupling location of the peripheral device and utilize the determined coupling location to determine the proximity of the peripheral device to the audio source.

In other examples, the peripheral device can include a location tracking device to provide location information to the computing device. In some examples, the peripheral device can utilize wired or wireless communication to provide the location information to the computing device. In some examples, the computing device can utilize the location information to determine a proximity or distance between the peripheral device and the source of the audio signal. In some examples, the computing device can determine the location and/or proximity of the peripheral device relative to the source of the audio signal based on properties of the received audio signal at the second microphone of the peripheral device. For example, the computing device can compare the sound properties of audio data generated from the audio signal received at the second microphone with audio data generated from the audio signal received at the first microphone. In this way, the computing device can be utilized to determine a relative location of the second microphone relative to the source of the audio signal.

The instructions 112, when executed by a processing resource such as the processing resource 102, can include instructions to alter a sound property of the audio signal based on a location of the first microphone and the location of the second microphone. As used herein, altering a sound property of an audio signal can include altering a feature of the sound property such as, but not limited to: a volume, a signal, a noise, an amplitude, a speed, a wavelength, among other features that can be attributed to sound waves. In some examples, the sound properties can be altered to increase a signal to noise ratio of the audio signal and/or audio data generated based on the audio signal. In this way, a relative sound quality of the audio signal and/or audio data can be increased.

Altering a sound property of the audio signal can be based on a location of the first microphone and/or the location of the second microphone. For example, the location of the first microphone can be determined to be further away from the audio source than the second microphone. In this example, the audio signal from the second microphone can be selected as a primary audio signal and the audio signal from the first microphone can be selected as a secondary audio signal. In this example, the noise from the secondary audio signal can be utilized to remove noise from the primary audio signal to increase a quality of the primary audio signal that can be utilized for a particular function (e.g., utilized for transmission to a different device, utilized for storage of the audio signal, etc.). In this way, the audio signal from the audio source can be altered utilizing both of the second microphone of the peripheral device with the first microphone of the computing device.

In some examples, the memory resource 104 can include instructions, that when executed by a processing resource such as the processing resource 102, can cause the processing resource 102 to determine a proximity of the peripheral device with respect to the first microphone. As described herein, the processing resource 102 can be utilized to determine a relative location of the peripheral device and a relative location of the first microphone of the computing device. In these examples, the processing resource 102 can be utilized to compare the determined location of the peripheral device or microphone of the peripheral device to the determined location of the microphone of the computing device.

In these examples, the proximity of the peripheral device to the microphone of the computing device can be utilized to alter the sound properties of the audio signal received at the first microphone of the computing device and/or the audio signal received at the second microphone of the peripheral device. In some examples, an audio mixer can be utilized to alter the sound properties of the audio signal. As used herein, an audio mixer can include instructions to increase a signal to noise ratio of an audio signal and/or audio data associated with the audio signal. In some examples, the location information of the first microphone and the second microphone can be utilized by the audio mixer as described herein.

In some examples, the memory resource 104 can include instructions, that when executed by a processing resource such as the processing resource 102, can cause the processing resource 102 to select a primary microphone from the first microphone and the second microphone based on a signal to noise ratio of the audio signal received at the first microphone and the second microphone. In some examples, selecting a primary microphone can include determining a base audio file to be utilized by the audio mixer. For example, the primary microphone can be utilized for altering properties since the primary microphone is generating audio data with a relatively greater signal to noise ratio and/or a greater audio quality compared to audio data received by other microphones. Resulting audio data from an audio mixer can have a relatively higher quality when a relatively higher quality audio data is utilized by the audio mixer.

In some examples, the memory resource 104 can include instructions, that when executed by a processing resource such as the processing resource 102, can cause the processing resource 102 to compare a first noise received by the first microphone to a second noise received by the second microphone. In some examples, the processing resource 102 can cancel the first noise when the first noise is greater than the second noise and cancel the second noise when the second noise is greater than the first noise. As used herein, noise can refer to audio data that is not part of an intended audio signal generated by the audio source. For example, a device such as a radio can be generating audio signals near a user speaking into a microphone. In this example, the audio signals generated by the radio can be classified as noise and the audio signals generated by the user speaking can be classified as the signal. By removing more of the audio signals generated by the radio can increase the quality of the audio signals generated by the user speaking.

In some examples, the memory resource 104 can include instructions, that when executed by a processing resource such as the processing resource 102, can cause the processing resource 102 to instruct a third microphone, disposed within the enclosure of the computing device at a third location opposite to the first location, to receive the audio signal at the third location. In these examples, the processing resource 102 can cancel a third noise received by the third microphone from a first audio data captured by the first microphone and a second audio data captured by the second microphone. In some examples, the first microphone can be disposed on a display side of the computing device enclosure and the third microphone can be disposed on a rear side of the computing device enclosure.

For example, the third microphone can be a microphone to capture ambient sound that can be utilized to remove additional noise that exists within the area of the computing device. In some examples, the noise received by the third microphone can be utilized to identify noise that can be utilized to determine a quantity of noise within an audio signal received by the first microphone and/or the second microphone. In some examples, the processing resource 102 can extract noise from the second audio data and utilize the extracted noise to cancel noise from the first audio data. In this way, the audio signal can be altered by canceling or removing noise from the captured audio data received by the first microphone and/or the second microphone.

In some examples, the memory resource 104 can include instructions, that when executed by a processing resource such as the processing resource 102, can cause the processing resource 102 to activate the second microphone as a primary microphone based on a set of criteria. In some examples, the criteria can include a signal to noise ratio, a proximity to the audio source, an environment of the audio source, a location of the first microphone, or a combination thereof. As described herein, the primary microphone can be selected based on the audio quality of received at the particular microphone. In some examples, the criteria can be utilized to determine the audio quality of audio signals and/or audio data. Although particular criteria are listed to determine the quality of audio, additional or fewer criteria can be utilized to determine the quality of the audio.

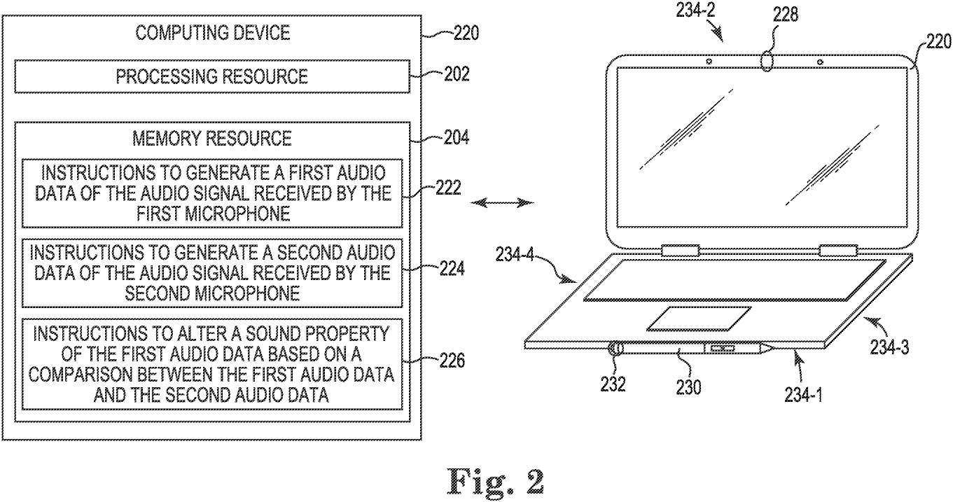

FIG. 2 illustrates an example of a computing device 220 for utilizing peripheral microphones. In some examples the computing device 220 can include a processing resource 202 communicatively coupled to a memory resource 204. As described further herein, the memory resource 204 can include instructions 222, 224, 226 that can be executed by the processing resource 202 to perform particular functions. In some examples, the computing device 220 can be associated with a microphone 228 and/or peripheral devices such as peripheral device 230.

As described herein, the computing device 220 can be utilized to receive audio signals from audio sources. For example, the computing device 220 can include a microphone 228 to receive sound that is generated by a user. In this example, the sound generated by the user can be vocal sounds or other sounds that are generated. The processing resource 202 can be a component of the computing device 220 such as a processor, an application specific integrated circuit (ASIC), a field programmable gate array (FPGA), a metal-programmable cell array (MPCA), or other combination of circuitry and/or logic to orchestrate execution of instructions 222, 224, 226. In other examples, the computing device 220 can include instructions 222, 224, 226 stored on a machine-readable medium (e.g., memory resource 204, non-transitory computer-readable medium, etc.) and executable by a processing resource 202. In a specific example, the computing device 220 can utilize a non-transitory computer-readable medium storing instructions 222, 224, 226 that, when executed, cause the processing resource 202 to perform corresponding functions.

In some examples, the computing device 220 can include instructions 222 that can be executed by a processing resource 202 to generate a first audio data of the audio signal received by the first microphone 228. In some examples, generating the first audio data can include receiving the audio signal at the first microphone 228 and converting the audio signal into audio data that can be utilized by the computing device 220 to perform particular functions. For example, the location of the first microphone and audio data can be provided to an audio mixer to increase the signal to noise ratio of the generated audio data captured by the first microphone 228.

In some examples, the computing device 220 can include instructions 224 that can be executed by a processing resource 202 to generate a second audio data of the audio signal received by the second microphone 232. As described herein, the second microphone 232 can be part of or coupled to a peripheral device 230. Although the peripheral device 230 is illustrated as a stylus, but the present disclosure is not limited to a stylus being the peripheral device 230. In some examples, the peripheral device 230 can utilize a plurality of coupling locations 234-1, 234-2, 234-3, 234-4. As used herein, a coupling location of the peripheral device 230, such as coupling locations 234-1, 234-2, 234-3, 234-4, can be locations on the enclosure of the computing device 220 that can support the peripheral device. In some examples, the coupling locations 234-1, 234-2, 234-3, 234-4 can be utilized to store, charge, transfer data, and/or perform other functions between the computing device 220 and the peripheral device 230.

In some examples, the coupling locations 234-1, 234-2, 234-3, 234-4 can be utilized to indicate a location of the peripheral device 230. For example, the coupling locations 234-1, 234-2, 234-3, 234-4 can include ports that can communicatively couple the peripheral device 230 to the computing device 220 when the peripheral device is coupled to one of the coupling locations 234-1, 234-2, 234-3, 234-4. For example, the coupling locations can include an input/output port (e.g., universal serial bus (USB), etc.) that can be utilized to communicatively couple the peripheral device 230 to the coupling locations 234-1, 234-2, 234-3, 234-4. In other examples, a sensor can be positioned at the coupling locations 234-1, 234-2, 234-3, 234-4 to detect when the peripheral device 230 is coupled at a particular coupling location of the coupling locations 234-1, 234-2, 234-3, 234-4. For example, a sensor at the coupling location 234-1 can provide a notification to the computing device 220 when the peripheral device 230 is coupled to or near the coupling location 234-1. In this way, the computing device can utilize the coupling locations 234-1, 234-2, 234-3, 234-4 to determine a physical location of the peripheral device 230 and/or the physical location of the microphone 232 of the of the peripheral device 230.

In some examples, the peripheral device 230 can provide location information of the microphone 232 of the peripheral device 230 to the computing device 220. For example, the peripheral device 230 can indicate where the microphone 232 is located within the peripheral device 230 to allow the computing device 220 to more accurately identify the physical location of the microphone 232 of the peripheral device 230.

In some examples, an audio signal can be received by the first microphone 228 and a first audio data can be generated based on the received audio signal. In a similar way, the audio signal can be received by the second microphone 232 of the peripheral device 230 and a second audio data can be generated based on the received audio signal. In some examples, the computing device 220 can include instructions 226 that can be executed by a processing resource 202 to alter a sound property of the first audio data based on a comparison between the first audio data and the second audio data. As described herein, the first audio data and the second audio data can be provided to an audio mixer to alter sound properties of the audio data.

In some examples, the first audio data and the second audio data can be compared to select the audio data with a relatively greater audio quality. When the audio data is selected based on the comparison, the selected audio data can be altered by the audio mixer to increase a signal to noise ratio of the selected audio data. In some examples, a sound property of the second audio data can be altered when a signal to noise ratio of the second audio data is greater than a signal to noise ratio of the first audio data. In addition, the location of the first microphone 228 and/or the location of the second microphone 232 can be provided to the audio mixer to improve the detection of sound compared to noise as described herein.

In some examples, an alert can be generated that includes instructions to alter the second location of the peripheral device 230 to a different location to increase a quality of the second audio data. For example, the second audio data can be below a signal to noise ratio threshold. In this example, an alert can be provided to a user or device to move the peripheral device 230 to a particular location (e.g., right, left, up, down, closer to the computing device 220, closer to the audio source, etc.) that is different than a current location. In some examples, the alert can be canceled when the signal to noise ratio of the second microphone 232 is above the signal to noise ration threshold.

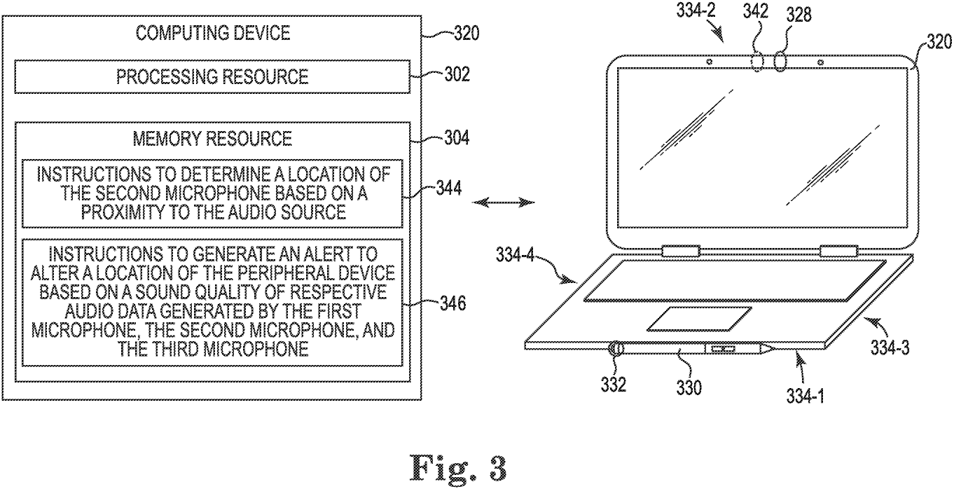

FIG. 3 illustrates an example of a computing device 320 for utilizing peripheral microphones. In some examples, the computing device 320 can be a similar device as computing device 220 as referenced in FIG. 2. In some examples the computing device 320 can include a processing resource 302 communicatively coupled to a memory resource 304. As described further herein, the memory resource 304 can include instructions 344, 346 that can be executed by the processing resource 302 to perform particular functions. In some examples, the computing device 320 can be associated with a microphone 328 and/or peripheral devices such as peripheral device 330.

In some examples, the computing device 320 can include similar elements as computing device 220 as illustrated in FIG. 2. For example, the computing device 320 can include a plurality of coupling locations 334-1, 334-2, 334-3, 334-4 that can be utilized to couple the peripheral device 330 to the enclosure of the computing device 320 and/or detect a relative location of the peripheral device 330. In some examples, the peripheral device 330 can be a stylus that can be coupled to one of the coupling locations 334-1, 334-2, 334-3, 334-4 and utilized as an additional microphone for the computing device 320 by utilizing the microphone 332 of the peripheral device 330 with the microphone 328 of the computing device 320.

In some examples, the computing device 320 can include instructions that can be executed by a processing resource 302 to determine a first location of the first microphone (e.g., microphone 328, etc.) based on a coupling location of the first microphone. In some examples, the first microphone can be microphone 328 that is permanently or semi-permanently disposed within the enclosure of the computing device 320. In some examples, the microphone 328 can be an on-board microphone that is manufactured with the computing device 320 and/or considered part of the computing device 320. In this way, the location of the microphone 328 can be based on manufacturer data that is stored on the computing device 320.

In some examples, the computing device 320 can include instructions 344 that can be executed by a processing resource 302 to determine a location of the second microphone (e.g., microphone 332) based on a proximity to the audio source. As described herein, the microphone 332 can be coupled to or disposed within a peripheral device 330. In some examples, the location of the peripheral device 330 and/or the location of the microphone 332 of the peripheral device 330 can be determined based on a coupling location of the peripheral device 330. As described herein, the computing device 320 can include a plurality of coupling locations 334-1, 334-2, 334-3, 334-4 that can be utilized to couple the peripheral device 330 to the computing device 320. In some examples, the physical location of the peripheral device 330 and/or the microphone 332 of the peripheral device 330 can be utilized to determine the proximity of the microphone 332 to the audio source. In other examples, properties of the audio data captured by the microphone 332 can be compared to audio data captured by the microphone 328 to determine the proximity of the microphone 332 to the audio source. For example, a volume of the audio data captured by the microphone 328 can be compared to the volume of the audio data captured by the microphone 332 to determine whether the microphone 328 is closer to or farther away from the audio source compared to the microphone 332.

In some examples, the computing device 320 can include instructions that can be executed by a processing resource 302 to determine a third location of the third microphone (e.g., microphone 342, etc.) based on a coupling location of the third microphone. In some examples, the microphone 342 can be similar to microphone 328. For example, the microphone 342 can be permanently or semi-permanently coupled to the enclosure of the computing device 320. In some examples, the microphone 342 can be a microphone manufactured with the computing device 320. In some examples, the microphone 342 can be positioned opposite to the microphone 328. For example, the microphone 328 can be positioned on a first side (e.g., front side, side directed at a user in use, etc.) of the enclosure of the computing device 320 and the microphone 342 can be positioned on a second side (e.g., back side, rear side, side directed away from a user in use, etc.). In this way, the microphone 342 can be utilized to receive ambient sound within an area and/or detected noise within the area, which can be utilized by an audio mixer to increase a sound quality of audio data.

In some examples, the computing device 320 can include instructions 346 that can be executed by a processing resource 302 to generate an alert to alter a location of the peripheral device based on a sound quality of respective audio data generated by the first microphone, the second microphone, and the third microphone. As described herein, the audio data that is captured and/or generated by the microphones 328, 332, 342 can be utilized by an audio mixer to increase a quality of the captured audio data.

In some examples, the computing device 320 can determine that audio data from a different location would increase the audio quality. For example, the distance between the microphones 328, 342 may be beyond a threshold distance and the alert can include instructions to move microphone 332 closer to the audio source. In another example, the noise associated with the audio data may be difficult to identify for the computing device 320. In these examples, the alert can include instructions to move the microphone 332 further away from the audio source, further away from microphones 328, 342, and/or closer to a potential source of noise. In a specific example, the noise can be determined to be generated by computing components (e.g., fans, processors, etc.) of the computing device 320. In this example, the alert can include instructions to move the microphone 332 closer to a position of the computing components (e.g., closer to coupling location 334-1, etc.).

In some examples, the alert can include instructions to remove the peripheral device 330 from a first coupling location to a second coupling location. In other examples, the alert can include instructions to remove the peripheral device 330 from one of the coupling locations 334-1, 334-2, 334-3, 334-4 to a location between the microphone 328 and the audio source. In some examples, the alert can be utilized notify a user that there is a potential to increase a sound quality of the audio data by the audio mixer if additional audio data is captured at a different location.

In some examples, the computing device 320 can include instructions that can be executed by a processing resource 302 to compare the sound quality of the respective audio data generated by the first microphone (e.g., microphone 328), the second microphone (e.g., microphone 332), and the third microphone (e.g., microphone 342) to determine a corresponding microphone with a quality that is above a quality threshold. As used herein, a quality threshold can be a signal to noise ratio that is above a particular level that can be utilized as audio base data.

In these examples, the computing device 320 can select one of the respective audio data to utilize as the audio base data and/or select one of the microphones to utilize as a primary microphone. For example, the computing device 320 can include instructions that can be executed by a processing resource 302 to select the audio data generated by the first microphone (e.g., microphone 328, etc.) to utilize as audio base data when the audio data generated by the first microphone is above the quality threshold. In some examples, the computing device 320 can include instructions that can be executed by a processing resource 302 to select a microphone as a primary microphone for the computing device based on a selected audio base data. For example, the computing device 320 can select a microphone from microphone 328, microphone 332, and/or microphone 342 based on audio data generated by the respective microphones 328, 332, 342.

As described herein, the audio data that is not selected to be utilized as the audio base data can be utilized to identify noise that can be removed from the audio base data. For example, the computing device 320 can include instructions that can be executed by a processing resource 302 to identify noise from audio data not selected to be utilized as the audio base data. In this example, the computing device 320 can include instructions that can be executed by a processing resource 302 to remove noise from the audio base data utilizing the identified noise from a plurality of audio data not selected to be utilized as the audio base data.

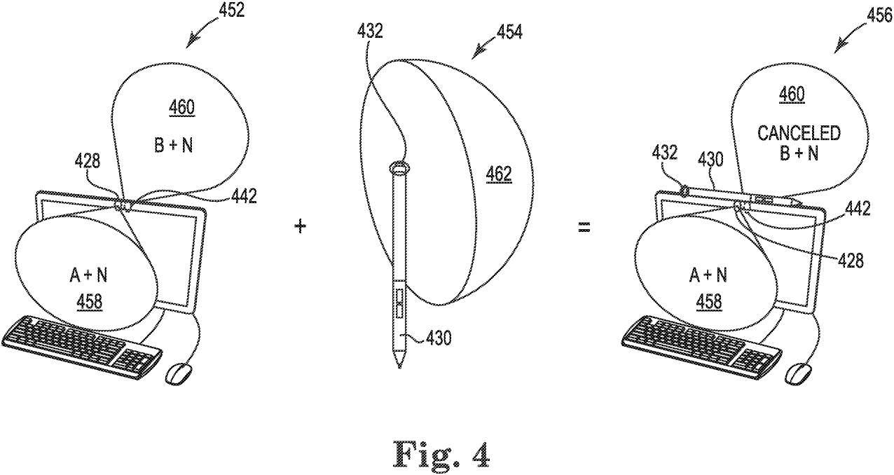

FIG. 4 illustrates an example of a system 400 for utilizing peripheral microphones. The system 400 is illustrated in three portions 452, 454, 456. The first portion 452 illustrates a computing device 420 that includes a first microphone 428 that can collect audio signals from a first area 458 and a second microphone 442 that can collect audio signals from a second area 460. As described herein, the first microphone 428 can be positioned on an opposite side as the second microphone 442. In this way, the first area 458 can be opposite to the second area 460.

The portion 454 illustrates a peripheral device 430. Although a stylus is illustrated as the peripheral device 430, other peripheral devices that are used with computing devices can be utilized. As described herein, the peripheral device 430 can include a microphone 432 that can collect audio signals from a third area 462. As described herein, the first microphone 428, second microphone 442, and third microphone 432 can be utilized together as illustrated by portion 456.

Portion 456 illustrates the peripheral device 430 coupled to a portion of the computing device 420. In some examples, the location of the third microphone 432 can be determined based on the coupling location of the peripheral device 430. In some examples, the computing device 420 can determine that the first microphone 428 and the third microphone 432 are to be utilized to capture audio signals from a particular audio source. In these examples, the second microphone 442 can be deactivated and/or the audio signals received from the second microphone 442 can be canceled or removed from the audio data captured by the first microphone 428 and/or the third microphone 432 to increase a quality of the audio data.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and method of the disclosure. Since many examples can be made without departing from the spirit and scope of the system and method of the disclosure, this specification merely sets forth some of the many possible example configurations and implementations.

What is claimed is:

1. A non-transitory memory resource storing machine-readable instructions, when executed, cause a processing resource of a computing device to:
instruct a first microphone of the computing device and a second microphone of a peripheral device to capture an audio signal generated by an audio source;
determine a location of the second microphone based on a proximity of the peripheral device to the audio source; and
alter a sound property of the audio signal based on a location of the first microphone and the location of the second microphone.

2. The memory resource of claim 1, comprising instructions, when executed further, cause the processing resource to determine a proximity of the peripheral device with respect to the first microphone.

3. The memory resource of claim 1, comprising instructions, when executed further, cause the processing resource to select a primary microphone from the first microphone and the second microphone based on a signal to noise ratio of the audio signal captured by the first microphone and the second microphone.

4. The memory resource of claim 1, comprising instructions, when executed further, cause the processing resource to:
compare a first noise captured by the first microphone to a second noise captured by the second microphone; and
cancel the first noise when the first noise is greater than the second noise and cancel the second noise when the second noise is greater than the first noise.

5. The memory resource of claim 4, comprising instructions, when executed further, cause the processing resource to:
instruct a third microphone of the computing device opposite to the first microphone of the computing device to capture the audio signal at a different location; and
cancel a third noise captured by the third microphone from a first audio data captured by the first microphone and a second audio data captured by the second microphone.

6. The memory resource of claim 1, comprising instructions, when executed further, cause the processing resource to activate the second microphone as a primary microphone based on a set of criteria, wherein the set of criteria includes signal to noise ratio, proximity to the audio source, location of the first microphone, or a combination thereof.

7. A computing device, comprising:
a first microphone to receive an audio signal at a first location, wherein the audio signal is generated by an audio source;
a second microphone of a peripheral device to receive the audio signal at a second location, wherein the peripheral device is coupled to the computing device;
a processing resource to:
generate a first audio data of the audio signal received by the first microphone;
generate a second audio data of the audio signal received by the second microphone; and
alter a sound property of the first audio data based on a comparison between the first audio data and the second audio data.

8. The computing device of claim 7, wherein the processing resource is to extract noise from the second audio data and utilize the extracted noise to cancel noise from the first audio data.

9. The computing device of claim 7, wherein the processing resource is to alter a sound property of the second audio data when a signal to noise ratio of the second audio data is greater than a signal to noise ratio of the first audio data.

10. The computing device of claim 8, wherein the processing resource is to generate an alert to alter the second location of the peripheral device to a different location to increase a quality of the second audio data.

11. A computing device, comprising:
a first microphone disposed within an enclosure of a computing device, wherein the first microphone is positioned in a first direction to receive audio signals from an audio source;
a second microphone of a peripheral device that is coupled to the computing device;
a third microphone disposed within the enclosure of the computing device, wherein the third microphone is positioned in a second direction to receive audio signals from the audio source; and
a processing resource to:
determine a location of the second microphone based on a proximity to the audio source; and
generate an alert to alter a location of the peripheral device based on a sound quality of respective audio data generated by the first microphone, the second microphone, and the third microphone.

12. The computing device of claim 11, wherein the processing resource is to:
compare the sound quality of the respective audio data generated by the first microphone, the second microphone, and the third microphone to determine a corresponding microphone with a quality that is above a quality threshold; and
select the audio data generated by the first microphone to utilize as audio base data when the audio data generated by the first microphone is above the quality threshold.

13. The computing device of claim 12, wherein the processing resource is to identify noise from audio data not selected to be utilized as the audio base data.

14. The computing device of claim 13, wherein the processing resource is to remove noise from the audio base data utilizing the identified noise from a plurality of audio data not selected to be utilized as the audio base data.

15. The computing device of claim 11, wherein the processing resource is to select a microphone as a primary microphone for the computing device based on a selected audio base data.
